(19) United States
(12) Patent Application Publication
(10) Pub. No.: US 2011/0283290 A1
(43) Pub. Date: Nov. 17, 2011

(54) ALLOCATING STORAGE SERVICES

(76) Inventors: Gary L. Thunquest, Windsor, CO (US); Matt Zinkevicius, Fort Collins, CO (US); Douglas L. Voigt, Boise, ID (US)

(21) Appl. No.: 12/781,524

(22) Filed: May 17, 2010

(51) Int. Cl. G06F 12/00; G06F 12/02; G06F 9/46

(52) U.S. Cl. 718/104; 711/114; 726/1; 711/E12.001

(57) ABSTRACT

A system and method are provided for allocating storage resources. An exemplary method comprises providing a storage service catalog that lists storage services available for use. The exemplary method also comprises allowing a user to select a subset of the storage services from among the storage services via a self-service software tool.

### BACKGROUND

A business network may include large numbers of computing resources and storage resources. Examples of computing resources include servers, workstations, desktop computers and the like. Examples of storage resources include multiple disk arrays, network-attached storage (NAS) devices, and the like.

In an enterprise datacenter, computing resources and storage resources may be grouped into compute resource pools and storage resource pools. Physical or virtual servers are constructed to run business applications using resources from available compute and storage resource pools to form a platform which meets the needs of the applications and data. In addition, operations in the datacenter must typically be performed with provisioning policies that are used to provide effective management of resources within the datacenter.

Provisioning of storage resources using current techniques may be inefficient. For example, ad hoc methods such as sending an email requesting provisioning of storage resources are typically used. In response, a storage administrator may be required to manually provision storage resources, taking into account relevant provisioning policies. Provisioning storage resources in this manner may take a relatively long time (for example, several days).

The use of ad hoc provisioning requests may result in additional problems. For example, the individual making the provisioning request may be unfamiliar with procedures in the datacenter. The requester may, accordingly, not be able to effectively communicate a provisioning request in a way that can be readily understood by storage administrators.

### BRIEF DESCRIPTION OF THE DRAWINGS

Certain exemplary embodiments are described in the following detailed description and in reference to the drawings, in which:

FIG. 1 is a block diagram presenting a conceptual overview of an enterprise storage system, in accordance with exemplary embodiments of the present invention;

FIG. 2 is a block diagram of a system for allocating storage resources, in accordance with an exemplary embodiment of the present invention;

FIG. 3 is a block diagram of a storage catalog, in accordance with an exemplary embodiment of the present invention;

FIG. 4 is a process flow diagram of a method for allocating storage resources, in accordance with an exemplary embodiment of the present invention; and

FIG. 5 is a block diagram showing a tangible, machine-readable medium that stores code adapted to perform allocation of storage resources according to an exemplary embodiment of the present invention.

### DETAILED DESCRIPTION OF SPECIFIC EMBODIMENTS

An exemplary embodiment of the present invention relates to an automatable classification and matching system that can be used to match data storage needs with available data storage resources while adhering to datacenter provisioning policies. Datacenter provisioning policies take into account a wide range of issues such as ownership of resources, provisioning construction standards, security, access rights, and best practices to name just a few examples.

Provisioning policies may be implemented to ensure separation of types of data that should not be stored together (for example, sensitive employee-related data and data that is widely available). Another provisioning policy may require data owned by a particular group to be stored on resources owned by that group. Moreover, provisioning policies provide a logistical framework for the assignment of storage resources, taking into account the complex nature of managing resources in a modern datacenter.

One exemplary embodiment of the present invention comprises a system that presents a self-service portal to server administrators allowing selection of storage services from a catalog which satisfies the needs of the request while maintaining compliance with datacenter provisioning policies. Such a self-service portal ensures that provisioning policies are followed, but does not require the serial involvement of the storage administrator. Thus, an exemplary embodiment may allow the server administrator to receive access to pre-provisioned storage in minutes rather than days, while maintaining compliance with the provisioning policies implemented by the storage administrator.

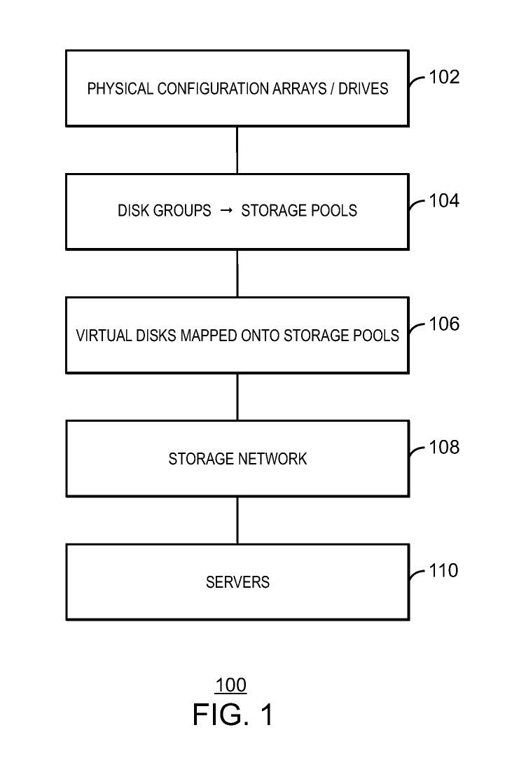

FIG. 1 is a block diagram presenting a conceptual overview of an enterprise storage system 100, in accordance with exemplary embodiments of the present invention. The enterprise storage system 100 has a physical configuration 102 that may include numerous storage arrays, each of which may have numerous disk drives of multiple types. For example, the storage arrays may include units such as a StorageWorks Enterprise Virtual Array (EVA), available from the Hewlett-Packard (HP) Company. The techniques described herein are not limited to the EVA, as they may be used with HP StorageWorks XP disk arrays, HP StorageWorks Modular Smart Arrays (MSA), and arrays available from other manufacturers. Moreover, exemplary embodiments of the present invention are not limited to specific types of storage.

As indicated by block 104, the disk drives of the array may be grouped into disk groups. Disk space from the disk groups can be organized into a first set of virtual disks. A virtual disk is a set of disk blocks from one or more disk drives that can be presented to a system as if it is a single disk storage device. Disk groups may be grouped together to form storage pools. As indicated at block 106, virtual disks within the system may be mapped onto the storage pools.

Storage pools may be used to provide storage services for use in the data center. In the exemplary embodiment shown in FIG. 1, a storage network 108 provides access to the virtual disks 106 by one or more servers 110. The storage network 108 may employ any suitable protocol suite, such as fiber channel, iSCSI fiber channel over Ethernet, to name just a few examples. In one exemplary embodiment, the storage network 108 may comprise a storage area network (SAN). In addition, those of ordinary skill in the art will appreciate that direct-attached storage, which may be directly connected to the servers 110 and not accessed using a storage network, may also be deployed in a datacenter. Moreover, exemplary embodiments of the present invention are not limited to a particular type of storage.

Datacenter storage resources, such as virtual disks and storage pools, may be grouped into storage services. Storage services may provide a particular level of performance at an associated cost. Moreover, storage services may be defined according to a wide range of usage parameters, such as guaranteed capacity, resiliency or performance. For example, a storage service may be defined to provide a specific amount of storage at a particular bandwidth or speed. Another storage service may provide a desired amount of guaranteed availability or uptime.

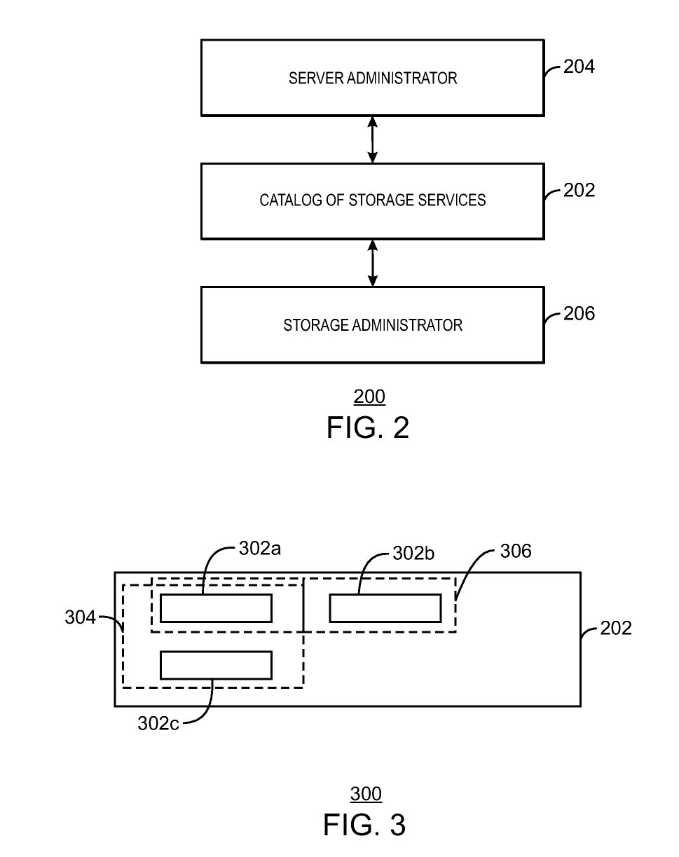

FIG. 2 is a block diagram of a system for allocating storage resources, in accordance with an exemplary embodiment of the present invention. The system is generally referred to by the reference number 200. The system 200 includes a catalog 202 of storage services. The catalog 202 functions as a repository of storage services that may be accessible by both a server administrator 204 and a storage administrator 206, or by software operating on behalf of the administrators.

In a typical datacenter, the server administrator 204 manages servers and other computing resources. The server administrator 204 may have responsibility for providing computing resources for a specific group of a larger enterprise such as a human resources department or a finance department. The storage administrator 206 manages storage resources such as storage services. As explained herein, exemplary embodiments of the present invention provide a management software component or tool that allows the server administrator 204 to access and allocate storage services while maintaining compliance with provisioning policies of a datacenter.

In an exemplary embodiment of the present invention, the storage administrator 206 may classify storage resources into inventories of pre-provisioned storage services. As explained herein, each storage service may correspond to a particular performance level, having an associated cost. At any given time, available storage services may be displayed in the catalog 202. The server administrator 204 may browse the catalog 202 via a software tool to select storage services needed to satisfy a particular computing job. When available pre-provisioned storage services are selected, the software tool may provide access to the pre-provisioned storage services in a relatively short time, without direct involvement by the storage administrator 206.

When classifying storage services, the storage administrator 206 may use a dictionary of tags representing various types of storage services and/or storage service characteristics. A tag is a label or identifier that may be used to classify storage services based on their capabilities. The tag dictionary forms a vocabulary used by the storage administrator 206 to classify the storage services in the catalog.

The tags used to classify storage services may be defined based on characteristics of the storage services. Service quality is one characteristic that may be used to classify the storage services. Service quality covers a wide range of aspects of storage service operation, including performance, capacity, resiliency, and availability to name just a few examples.

The same vocabulary used to classify the storage services may be used by the server administrator 204 to express needs for storage resources. In this manner, exemplary embodiments of the present invention allow the server administrator 204 and the storage administrator 206 to use the catalog 202 to define a needs communication vocabulary to precisely capture and communicate the storage service needs of the server administrator 204. The common needs communication vocabulary helps to ensure that the storage service needs of the server administrator 204 are fulfilled accurately, while maintaining compliance with datacenter provisioning policies.

In general, the storage administrator 206 may define a tag applied to a storage service to embody any semantic desired for the storage service. For example, tags can be used to embody the notion of an intended use, quality of service, or can embody the presence of a capability of the storage service that would be of interest to the server administrator 204. A BOOT tag might be defined to mean that the storage service is intended to be used as a boot volume holding an operating system (OS) image. A DR-Capable tag might be defined to mean that a form of disaster recovery replication can be performed on this storage service. Moreover, tags can be used to control the mapping of different types of storage services to specific devices the storage administrator 206 wants to be the provider of those services.

In an exemplary embodiment, tag definitions may be created by the storage administrator 206 based on the specific needs of a particular datacenter. Moreover, tag definitions may be totally customizable by the storage administrator 206. One use of tags allows the storage administrator 206 to classify storage services in the catalog 202 in a way that is consistent with the provisioning policies of the datacenter. As an example, tag definitions may be made by the storage administrator 206 such that the server administrator 204 is only able to view storage services that, if selected by the server administrator 204 for a particular task, comply with datacenter provisioning policies. In this manner, exemplary embodiments of the present invention allow the storage administrator 206 to provide ready access to storage services by the server administrator 204, while maintaining compliance with datacenter provisioning policies.

FIG. 3 is a block diagram of the storage catalog 202, in accordance with an exemplary embodiment of the present invention. As explained herein, exemplary embodiments allow the server administrator 204 to use the catalog 202 to match storage needs expressed through tag selection and other physical storage properties to a storage service from the catalog 202.

Beyond the ability to control the selection process using tags, the storage administrator 206 can set security access control lists (ACLs) on a plurality of storage services 302a, 302b and 302c listed in the catalog 202. ACLs can be used to further control the storage service selection process being performed by the server administrator 204. Moreover, ACLs may allow the storage administrator 206 to enforce policies controlling which server administrators are allowed to select which storage services.

The storage administrator 206 can control which storage services may be used by different server administrators using a namespace concept. In an exemplary embodiment of the present invention, namespaces may be defined using tags and ACLs. Namespaces may contain tags and may be made available to groups of users through ACLs on the namespaces. This allows the storage administrator 206 to define and enforce policies regarding to which tags may be used by different user groups. The storage administrator 206 can individually map each namespace's tag to the applicable storage services that will satisfy a request containing a particular tag. In one exemplary embodiment, the same tag used by two different groups (but in separate namespaces) may be allowed to map to different storage services. Using this technique, if a first group (e.g., a marketing department) uses a BOOT tag, the marketing BOOT tag can map to different storage services than if a second group (e.g., a finance group) uses a BOOT tag. This result may be accomplished by placing the tags in different namespaces.

FIG. 3 is useful in explaining the concept of namespaces. In particular, a namespace 304, represented by dashed lines, may be defined to include tags corresponding to the storage service 302a and the storage service 302c. The storage services referred to by the tags that make up the namespace 304 may be available to all server administrators in a particular group or organization. For example, the namespace 304 may be identified for a human resources group, meaning that only server administrators in the human resources group may view the storage services 302a and 302c when viewing the catalog 202.

A second namespace 306, represented by dashed lines, may be defined to include tags corresponding to the storage services 302a and 302b. The storage services referred to by the tags that make up the second namespace 306 may be available to all server administrators in a different group or organization. For example, the namespace 306 may be identified for a finance group, meaning that only server administrators in the finance group may view the storage services 302a and 302b when viewing the catalog 202.

To help manage the use of tags and security ACLs, the catalog 202 may also provide a mechanism to create groups of storage services. Storage service groups are useful for applying a set of tags and security to all of the services within the storage service group.

In an exemplary embodiment of the present invention, storage services may inherit tag and security values from a particular device. The use of inheritance may simplify the process by which the storage administrator 206 classifies storage services by device or by arbitrary group.

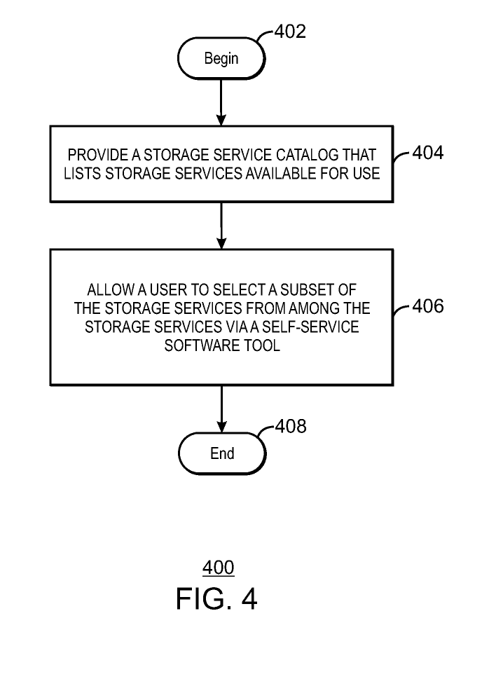

FIG. 4 is a process flow diagram of a method for allocating storage resources, in accordance with an exemplary embodiment of the present invention. The process is generally referred to by the reference number 400. At block 402, the process begins.

At block 404, a storage service catalog that lists pre-provisioned storage services available for use is provided. A portion of the list showing a subset of the storage services may be displayed to a storage administrator 204, such that the only storage services shown in the portion of the list would ensure compliance with a datacenter provisioning policy if selected by the storage administrator 204. As set forth herein, the list may be characterized using a wide range of techniques. Examples of such techniques include the use of tags, the use of ACLs or the use of namespaces.

A user is allowed to select a subset of the pre-provisioned storage services from among the pre-provisioned storage services via a self-service software tool, as shown at block 406. At block 408, the process ends.

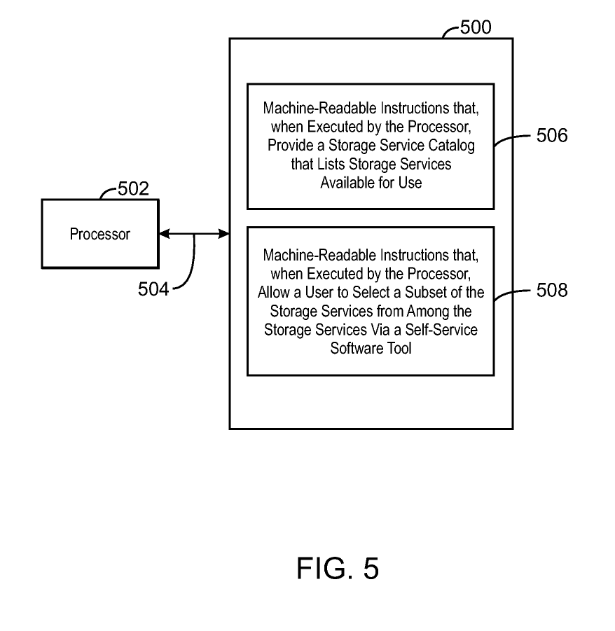

FIG. 5 is a block diagram showing a tangible, machine-readable medium that stores code adapted to perform allocation of storage resources according to an exemplary embodiment of the present invention. The tangible, machine-readable medium is generally referred to by the reference number 500. The tangible, machine-readable medium 500 may correspond to any typical storage device that stores computer-executed instructions, such as programming code or the like. As will be readily apparent to one of ordinary skill in the art, computer-executable instructions stored on the tangible, machine-readable medium 500 may be read and executed a processor 502 via a system bus 504.

A region 506 of the tangible, machine-readable medium 500 stores machine-readable instructions that, when executed by the processor 500, provide a storage service catalog that lists pre-provisioned storage services available for use. According to an exemplary embodiment, a server administrator may select individual storage services or combinations thereof to be used for a particular task. A region 508 of the tangible, machine-readable medium 500 stores machine-readable instructions that, when executed by the processor, allow a user to select a subset of the pre-provisioned storage services from among the pre-provisioned storage services via a self-service software tool.

What is claimed is:

1. A computer-implemented method for allocating storage resources, comprising:
providing a storage service catalog that lists storage services available for use; and
allowing a user to select a subset of the storage services from among the storage services via a self-service software tool.

2. The computer-implemented method for allocating storage resources recited in claim 1, comprising displaying only a set of storage services to a user that ensures compliance with a storage provisioning policy if selected by the user.

3. The computer-implemented method for allocating storage resources recited in claim 2, wherein the storage provisioning policy comprises a security policy.

4. The computer-implemented method for allocating storage resources recited in claim 1, comprising displaying the storage services in groups based on a characteristic of the storage services as defined in a vocabulary.

5. The computer-implemented method for allocating storage resources recited in claim 1, comprising classifying the storage resources based on service quality using a plurality of tags that correspond to service quality characteristics.

6. The computer-implemented method for allocating storage resources recited in claim 5, wherein the plurality of tags comprises a BOOT tag and a disaster recovery (DR)-capable tag.

7. The computer-implemented method for allocating storage resources recited in claim 1, wherein the storage services are pre-provisioned.

8. The computer-implemented method for allocating storage resources recited in claim 1, comprising defining a plurality of namespaces to characterize the storage services.

9. The computer-implemented method for allocating storage resources recited in claim 1, wherein the storage resources are characterized by a level of guaranteed capacity, a level of guaranteed resiliency and/or a level of guaranteed performance.

10. A storage system, comprising:
a plurality of storage arrays, wherein each of the plurality of storage arrays comprises a plurality of disk drives;
at least one server that is adapted to access the plurality of storage arrays; and
a software tool that allows a user to select storage services from a catalog of storage services and to allocate the storage services for a specific purpose.

11. The storage system recited in claim 10, wherein the software tool displays only a set of storage services to a user that ensures compliance with a storage provisioning policy if selected by the user.

12. The storage system recited in claim 11, wherein the storage provisioning policy comprises a security policy.

13. The storage system recited in claim 10, wherein the software tool displays the storage services in groups based on a characteristic of the storage services as defined in a vocabulary.

14. The storage system recited in claim 10, wherein the software tool classifies the storage resources based on service quality using a plurality of tags that correspond to service quality characteristics.

15. The storage system recited in claim 14, wherein the storage services are pre-provisioned.

16. The storage system recited in claim 10, wherein a plurality of access control lists is employed to characterize the storage services.

17. The storage system recited in claim 10, wherein a plurality of namespaces is employed to characterize the storage services.

18. The storage system recited in claim 10, wherein the storage resources are characterized by a level of guaranteed capacity, a level of guaranteed resiliency and/or a level of guaranteed performance.

19. A non-transitory, computer-readable medium, comprising code configured to direct a processor to:
provide a storage catalog that lists storage services available for use; and
allow a user to select from among the storage services via a self-service software tool.

20. The non-transitory, computer-readable medium recited in claim 19, comprising code configured to direct a processor to display to a user only a set of storage services that ensures compliance with a storage provisioning policy if selected by the user.
